(19) United States
(12) Patent Application Publication
(10) Pub. No.: US 2008/0223369 A1
(43) Pub. Date: Sep. 18, 2008

(54) PERSONAL OXYGEN AND AIR DELIVERY SYSTEM

(76) Inventor: Sydney Warren, Edina, MN (US)

Correspondence Address: BELASCO, JACOBS & TOWNSLEY LLP;HOWARD HUGHES CENTER, 6100 CENTER DRIVE, SUITE 630, LOS ANGELES, CA, 90045, US

(21) Appl. No.: 12/131,746

(22) Filed: Jun. 2, 2008

Related U.S. Application Data
(62) Division of application No. 10/945,546, filed on Sep. 20, 2004.

(51) Int. Cl. A62B 18/02

(52) U.S. Cl. 128/205.25

(57) ABSTRACT

A portable gas delivery system includes a mouthpiece, a gas delivery pack and a tubing assembly. The mouthpiece has an upper region and a lower region extending therefrom. The upper region includes a least one nose port. The lower region includes a mouth port. The gas delivery pack has a gas storage region, a gas compression region, or a combination thereof. The tubing assembly operably attached to the mouthpiece and the gas delivery pack for delivering gas from the gas delivery pack to the mouthpiece.

### REFERENCE TO RELATED APPLICATIONS

The present application claims the benefit of U.S. Provisional Application No. 60/504,268 filed Sep. 18, 2003 and U.S. Provisional Application No. 60/519,489 filed Nov. 13, 2003, which are incorporated herein in their entirety by reference. This application is a divisional application of U.S. application Ser. No. 10/945,546 filed Sep. 20, 2004.

### FIELD OF THE INVENTION

The invention relates generally to a system for delivering oxygen and/or air. More particularly, the invention relates to a portable system for delivering oxygen and/or air to persons in a comfortable and convenient manner during daily activities.

### BACKGROUND OF THE INVENTION

Clean air is an important part of maintaining health in an otherwise healthy person. Environments that contain air-borne pollutants and infectious agents have received much publicity and awareness. Second hand cigarette smoke, carbon monoxide, SARS, dust, pollen and car exhaust, among other such pollutants can cause respiratory discomfort, damage or inefficiency.

Some of these effects can be temporary, as when exposed to an allergen where the effect disappears when the allergen is removed, and some of these effects can be permanent, as when second-hand cigarette smoke causes cancer. It is beneficial to an otherwise healthy person to maintain a high quality supply of breathable air by either filtering the ambient air before inhalation, or providing an alternate source for the breathable air that excludes a large fraction of the ambient air.

This effect is well known for unhealthy people, such as an emphysema patient who pulls a cart with an oxygen tank that supplies oxygen to an area around the nose or mouth to enhance the oxygen uptake of damaged lungs. Another example is the oxygen masks used in hospitals to provide a similar effect for the same or other medical purpose. These systems provide higher quality air in a manner that is not easily portable for an individual, and certainly not designed to be fashionable or attractive.

A personal oxygen and/or air delivery system must further meet certain functional requirements. It must be able to remove some potentially, perceived or actually harmful fraction of the ambient air, or must be able to provide at least a portion of the inhaled air by displacing at least a portion, if not all, of the ambient air with either air filtered by an air filtration pump, or air from a compressed gas tank of appropriate dimension so as to be worn on the body. In the alternative it may be required to do both functions, with some portion of the inhaled air coming through the filter, some portion coming from the gas tank, and the remaining air, if any, coming from the ambient air.

For the purposes of this application, higher quality air refers to air with either more desirable characteristics, air which has fewer undesirable characteristics, or air which has both more desirable and fewer undesirable characteristics. Percent O₂ content, pollen, particles, aromatic compounds, gaseous and particulate carbon compounds including hydrocarbons, nitrogen containing compounds, carbon monoxide, ozone, viral infectious agents, bacterial infectious agents, sulfur containing compounds, dust, soot, smoke, smog, and many other compounds can, among many other factors, be factors used when determining characteristics of air quality. Desirable and undesirable characteristics can be left to the objective determination of government and industry agencies or subjective determination of each individual user of this system.

As air quality in some cities declines, and as the perception that the number and quantity of harmful components in the air is increasing, there is a growing group of people who wish to breath higher quality air but are unwilling to pull a tank of higher quality air around in a cart, or unwilling to wear a standard mask or nose-piece normally associated with an unhealthy person, and thus convey a negative body image to others or to themselves.

Further, there has developed a desire by some people to stop periodically in commercial locations called oxygen bars, or commercial locations, like health clubs, that offer oxygen bars in addition to other services. These commercial locations provide customers with, among other services, an opportunity to temporarily inhale breathable air that can contain higher concentrations of oxygen.

Such breathable air may also be enhanced with aromas pleasing to the customer. Currently these customers use a small flexible hose called a cannula to deliver the oxygen-enriched breathable air into their nostrils. As part of the experience of being in an oxygen bar and social setting, it is desirable to portray the experience as glamorous or fashionable in addition to being functional.

Accordingly, it is desirable for the cannula to be incorporated into other devices normally appearing on or around the face of a person to enhance the appearance of glamour or fashion, or to disguise or otherwise hide the functional aspect of the cannula.

Various embodiments of the present invention are directed to addressing various needs in connection with ensuring that higher quality air is delivered to the nose and or mouth area of a person wearing the system disclosed in this invention.

Various patents address systems that are designed to permit the wearer to breathe oxygen or purified air. Sanders, U.S. Pat. No. 5,582,164, discloses a portable gas delivery system that includes a gas storage assembly that is connected to a nose piece using flexible tubing. The gas storage assembly includes a strap that enables it to be readily carried by the person using this system.

AmRhein, U.S. Pat. No. 4,996,983, discussed a portable oxygen delivery system in which gas storage containers are incorporated into the temples on eyeglasses. Air delivery tubes extend around the wearer's ears to a nose plug that is placed in the wearer's nose.

Peppler, U.S. Pat. No. 5,193,534; and Timmons et al., U.S. Pat. No. 4,559,941, both describe incorporating an oxygen delivery system into eyeglasses. The oxygen is delivered from a storage container to the temples on the eyeglasses. The oxygen is then routed to a nosepiece through the eyeglasses.

Koch et al., U.S. Pat. No. 4,465,067, discloses a system for delivering oxygen. This system has a configuration that is similar to eyeglasses except that it does not include any lenses. Oxygen is delivered to the temple portion that wraps around the wearer's ear and then to a nose piece that is positioned proximate the wearer's nose.

Izuchukwu et al., U.S. Pat. No. 6,526,968, discusses an air delivery system that is incorporated into a utility belt that is worn by the user. The utility belt includes a pack for storing the compressed gas and a port for connecting to a mask using flexible tubing.

Izuchukwu et al., U.S. Pat. No. 6,510,859, discloses an emergency breathing apparatus that includes a hood, which is placed over the user's entire head. Air is delivered to the hood from a storage pack. While such a system is acceptable for emergency situations, the fact that it covers the user's entire head limits the ability for the user to perform many activities while wearing this device.

### SUMMARY OF THE INVENTION

A portable gas delivery system includes a mouthpiece, a gas delivery pack, and a tubing assembly. The mouthpiece has an upper region and a lower region extending therefrom. The upper region includes a least one nose port. The lower region includes a mouth port. The gas delivery pack has a gas storage region, a gas compression region, or a combination thereof. The tubing assembly is operably attached to the mouthpiece and the gas delivery pack for delivering gas from the gas delivery pack to the mouthpiece.

### BRIEF DESCRIPTION OF THE DRAWINGS

FIG. 1 is a side view of a personal oxygen and air delivery system according to an embodiment of the invention.

FIG. 2 is a perspective view of the personal oxygen and air delivery system of FIG. 1.

FIG. 3 is an exploded perspective view of an attachment mechanism for the personal oxygen and air delivery system of FIG. 1.

FIG. 4 is a front view of a mouthpiece for the personal oxygen and air delivery system of FIG. 1.

FIG. 5 is a side view of the mouthpiece for the personal oxygen and air delivery system of FIG. 1.

FIG. 6 is a perspective view of the mouthpiece for the personal oxygen and air delivery system of FIG. 1.

FIG. 7 is a front view of an oxygen and air delivery pack for the personal oxygen and air delivery system of FIG. 1.

FIG. 8 is a perspective view of an alternative embodiment of the personal oxygen and air delivery system.

FIG. 9 is a top view of the personal oxygen and air delivery system of FIG. 8.

FIG. 10 is a front view of another embodiment of the personal oxygen and air delivery system.

FIG. 11 is a side view of the personal oxygen and air delivery system of FIG. 10.

FIG. 12 is a side view of a person wearing another embodiment of the personal oxygen and air delivery system.

FIG. 13 is a side view of another mouthpiece for use with the personal oxygen and air delivery system.

FIG. 14 is a front view of another mouthpiece for use with the personal oxygen and air delivery system.

FIG. 15 is a top view of another mouthpiece for use with the personal oxygen and air delivery system.

FIG. 16 is a side view of the mouthpiece of FIG. 15.

FIG. 17 is a side view of another mouthpiece for use with the personal oxygen and air delivery system.

FIG. 18 is a side view of another mouthpiece for use with the personal oxygen and air delivery system.

### DETAILED DESCRIPTION OF THE PREFERRED EMBODIMENTS

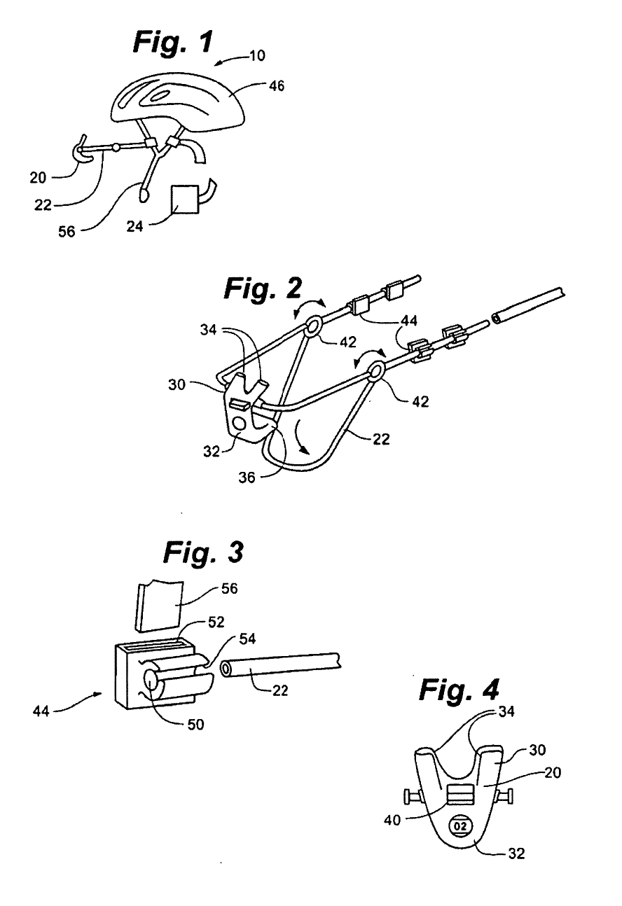

The invention is directed to a portable oxygen and air delivery system, as illustrated at 10 in FIG. 1. The portable oxygen and air delivery system 10 is particularly suited for use when performing activities such as riding a bicycle or running.

The portable oxygen and air delivery system 10 of the invention enables the person using this system to breathe purified air, more highly oxygenated air or combinations thereof.

The portable oxygen and air delivery system 10 thereby alleviates negative effects from breathing air with contaminants. The enhanced oxygen delivery from the portable oxygen and air delivery system 10 also permits the user to perform activities better.

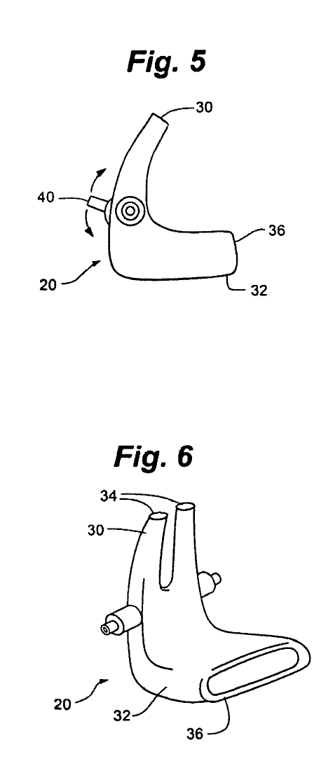

The portable oxygen and air delivery system 10 generally includes a mouthpiece 20, a tubing assembly 22, and an oxygen and air delivery pack 24. The mouthpiece 20 includes an upper region 30 and a lower region 32, as illustrated in FIGS. 1, 2, and 4-6.

The upper region 30 includes two nose ports 34 that extend into the user's nose when the portable oxygen and air delivery system 10 is used to deliver oxygen or air directly into the user's nose. Depending on the intended use conditions, the nose ports 34 may form a substantially air-tight seal with the user's nostrils such that the only oxygen or air entering the person's nose is through the mouthpiece 20.

The lower region 32 includes one mouth port 36 that is capable of extending into the user's mouth. Similar to the nose ports 34, the mouth port 36 may form a substantially airtight seal with the user's mouth such that the only oxygen or air entering the person's mouth is through the mouthpiece 20.

The mouthpiece 20 may have a U-shaped configuration such that the nose ports 34 can extend into the user's nostrils and the mouth port 36 can extend into the user's mouth without the mouthpiece being tight against the user's face.

The mouthpiece 20 may include a switch 40 for controlling the flow of oxygen and air through the mouthpiece 20. In its simplest form, the switch 40 turns on and off the oxygen and air flow. It is also possible for the switch 40 to vary the amount of air flow through the mouthpiece 20 as well as to control the ratio of oxygen to air that flows through the mouthpiece 20. In situations where the switch 40 controls the ratio of oxygen to air, the tubing assembly 22 could deliver oxygen through a first side and air through a second side.

As illustrated in FIGS. 1-3, the tubing assembly 22 may be fabricated in a symmetrical configuration where the tubing assembly extends around the left and right sides of the user's head. Each side of the tubing assembly 22 may include a rotatable connector 42 to assist with positioning the mouthpiece 20 in a desired position with respect to the user's mouth and nose.

The rotatable connected 42 also enables the mouthpiece to be moved to below the user's chin when it is desired to not use the portable oxygen and air delivery system 10 but it is desired for the portable oxygen and air system to be readily accessible for subsequent use.

Each side of the tubing assembly 22 may include an adapter 44 that has two recesses formed therein 50, 52, as most clearly illustrated in FIG. 3. The adapter 44 is capable of engaging a portion of a helmet 46 or similar device that is worn while using the portable oxygen and air delivery system 10. Alternatively, the adapter 44 may include an adhesive on an inner surface thereof that is attached to the skin of the user.

The first recess 50 is adapted to receive a portion of the tubing assembly 22. The first recess 50 can have a substantially cylindrical shape that is approximately the same size as the tubing assembly 22. The first recess 50 may be configured to restrict sliding of the tubing with respect to the adapter 44. A slot 54 may also be provided adjacent the first recess 50 to facilitate moving the tubing into and out of the first recess 50.

The second recess 52 is adapted to receive a portion of a strap 56 that extends from a helmet 46, which may be worn when the person is using the portable oxygen and air delivery system 10. The second recess 52 can have a substantially rectangular cross section that is approximately the same size as the strap 56. The second recess 52 may be configured to restrict sliding of the strap 56 with respect to the adapter 44. A slot (not shown) may also be provided adjacent the second recess 52 to facilitate moving the strap 56 into and out of the second recess 52.

While not shown, the tubing assembly 22 may include a connector that attaches to both sides of the tubing assembly 22 in back of the wearer's head. The connector would thereby enhance the ability to maintain the mouthpiece in a desired position with respect to the user's head.

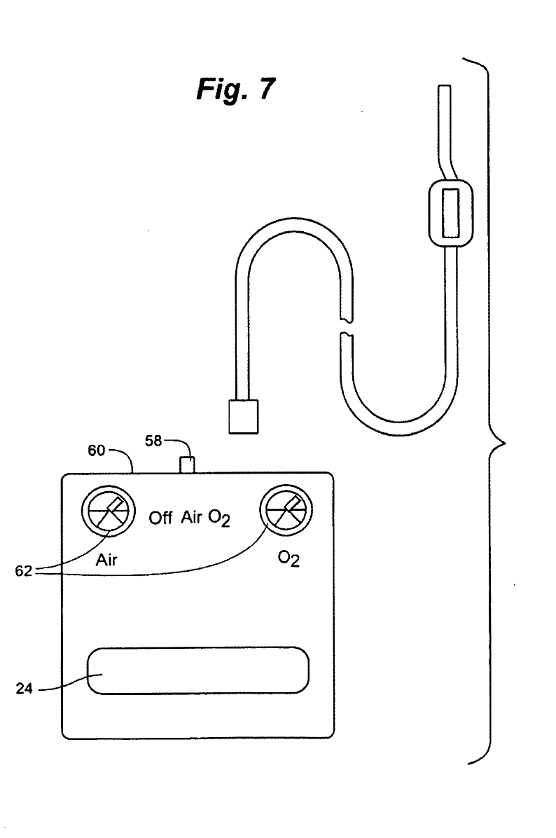

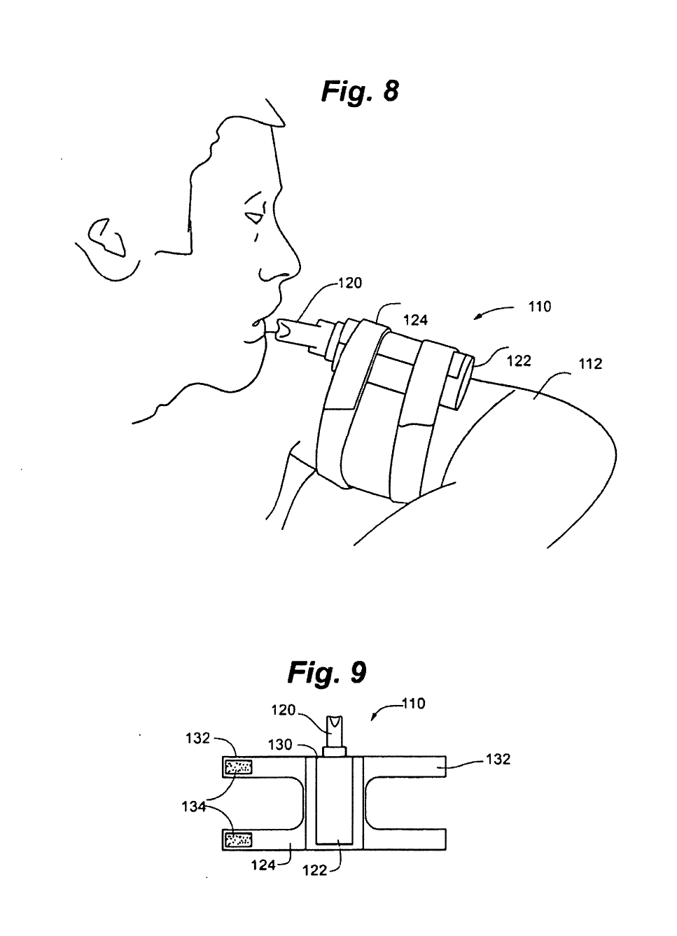

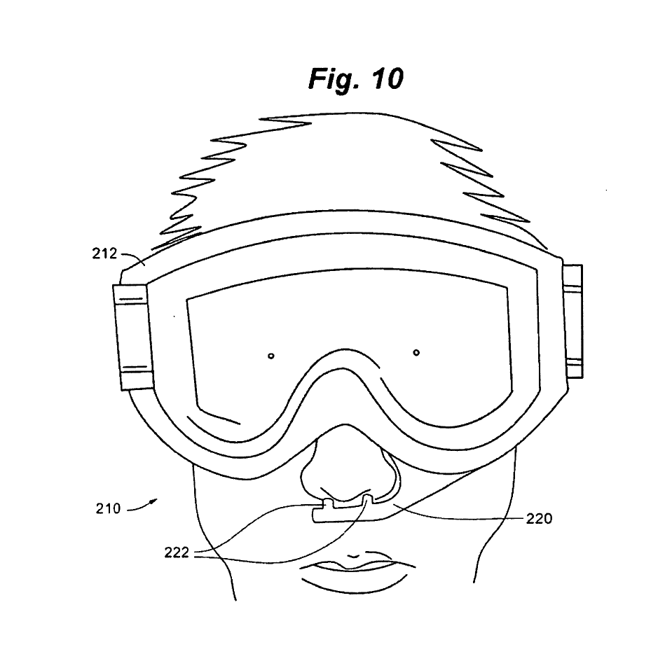

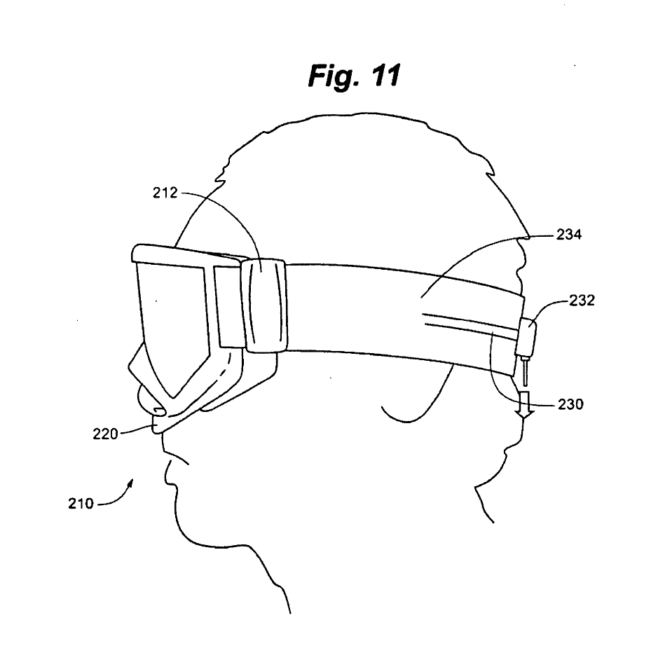

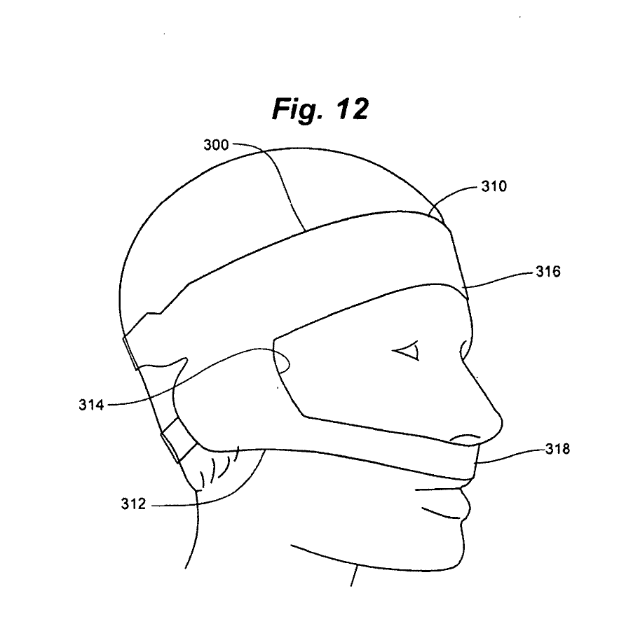

The oxygen and air delivery pack 24 is operably attached to an end of the tubing assembly 22 that is opposite the mouthpiece 20, as illustrated in FIG. 7. The oxygen and air delivery pack 24 may have a compact configuration that permits the oxygen and air delivery pack 24 to be worn by the user when performing various activities and may include a strap (not shown) to facilitate mounting the oxygen and air delivery pack 24 to a person's arm.

The oxygen and air delivery pack 24 has at least one outlet port 58 for attachment to the tubing assembly. To enhance the ability to use the oxygen and air delivery pack 24, this component may include a switch 60 that controls the delivery of oxygen and air as well as gauges 62 to show the oxygen and air pressure.

The oxygen and air delivery pack 24 may include one or more canisters (not shown) of compressed oxygen or air depending on the intended use of the portable oxygen and air delivery system 10. The oxygen and air delivery pack 24 may also include a compressor and filter (not shown) that receives ambient air and then purifies or enriches the ambient air.

An alternative configuration of the portable oxygen and air delivery system 110 is particularly suited for wearing on a user's arm 112. The portable oxygen and air delivery system 110 generally includes a mouthpiece 120, an oxygen and air delivery pack 122 and a harness 124.

This embodiment of the portable oxygen and air delivery system 110 is particularly suited for periodic use by the user turning his/her head towards the mouthpiece 120 so that the mouthpiece 120 extends into the user's mouth.

Flow of oxygen and air through the mouthpiece may be activated by the user compressing the mouthpiece 120 with his/her teeth. This configuration thereby permits the portable oxygen and air delivery system 110 to be used without the user touch the device with his/her hands. It is also possible to adapt the concepts of this embodiment so that flow of oxygen and air is initiated by a hand or foot control.

Similar to the embodiment illustrated in FIGS. 1-7, the oxygen and air delivery pack 122 may either include canisters of compressed oxygen and air or compressor and filter.

The harness 124 preferably maintains the oxygen and air delivery pack 122 in a substantially stationary position with respect to the user's arm 112 to enhance the ability of the user to access the mouthpiece 120 when desired while minimizing the potential interference to the user's desired activities while using the portable oxygen and air delivery system 110.

The harness 124 generally includes a recess 130 that is adapted to receive the oxygen and air delivery pack 122. The harness 124 may also include two pairs of straps 132 that are capable of extending around the user's arm proximate the upper and lower ends of the oxygen and air delivery pack 122. Ends of the straps 132 are preferably attached together with a removable fastening device such as a hook and loop fastener 134. Alternatively, the harness 124 may comprise a sleeve through which the user's arm extends.

Another embodiment of the portable oxygen and air delivery system 210 is particularly suited for use while performing activities in which goggles 212 or similar devices extend over the user's eyes, such as snorkeling and snow skiing. The portable oxygen and air delivery system 210 generally includes a nosepiece 220 that extends from a lower edge of the goggles 212.

The nosepiece 220 includes two nose ports 222 that extend into the user's nose when the portable oxygen and air delivery system 210 is used to deliver oxygen or air directly into the user's nose. Depending on the intended use conditions, the nose ports 222 may form a substantially air-tight seal with the user's nostrils such that the only oxygen or air entering the person's nose is through the nosepiece 220.

The nosepiece 220 may be attached to the goggles 212 only on a single side to facilitate bending the- nosepiece 220 to a position that is not in the user's nose when it is not desired to use the portable oxygen and air delivery system 210. Other embodiments of the portable oxygen and air delivery system 210 attach the nosepiece 220 on both sides to enhance the ability to maintain the nosepiece 220 in a desired position with respect to the user's nose.

A tubing assembly 230 extends from the nosepiece 220 to a connector 232 that may be attached to a back portion of a strap 234 on the goggles 212. The tubing assembly may be integrated at least partially into the strap 234 to facilitate maintaining the tubing assembly 230 in a substantially stationary position with respect to the strap 234.

The connector 232 is adapted to receive tubing that extends from an oxygen and air delivery pack (not shown). The oxygen and air delivery pack (not shown) may have a similar configuration to the oxygen and air delivery pack described with reference to the embodiment illustrated in FIGS. 1-7.

When performing certain activities, the user may need to wear an object such as a helmet that substantially covers the user's head. In these situations, the portable oxygen and air delivery system includes a harness 300 that extends over at least a portion of the user's head 302. The harness 300 thereby enables the oxygen and air to be delivered to the user's nose and mouth while enabling the helmet to fit snugly on the user's head.

The harness 300 can include an upper strap 310, a lower strap 312 and at least one interconnection panel 314 that is attached to the upper strap 310 and the lower strap 312. The upper strap 310 extends around the user's head so that a front portion 316 is on the user's forehead. The lower strap 312 extends around the user's head so that a front portion 318 is between the user's nose and mouth.

Tubing at least partially extends through the lower strap 312 so that oxygen and air can be delivered from an oxygen and air delivery pack (not shown) to proximate the user's nose and mouth. This embodiment may also include one or more ports that extend into either the user's nose or mouth.

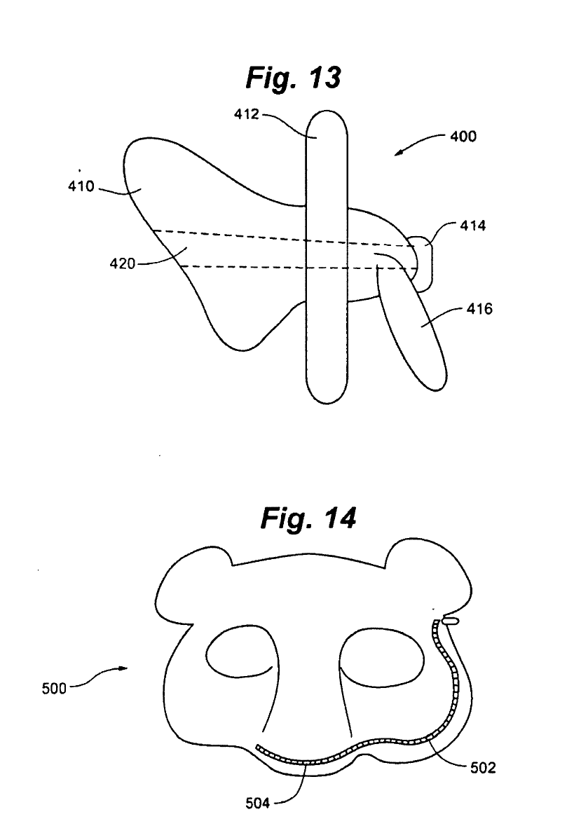

Another embodiment of the mouthpiece 400 is particularly suited for use by babies and young children, as illustrated in FIG. 13. The mouthpiece 400 has a shape that is similar to a conventional pacifier with an inner portion 410 that is capable of extending into the mouth of the user, a flange portion 412 that limits a distance to which the inner portion 410 may be inserted into the user's mouth, and an outer portion 414 that includes a ring 416 or other device to facilitate holding the mouthpiece 400 or attaching the mouthpiece 400 to another object to reduce the potential of the mouthpiece 400 being lost.

The mouthpiece 400 includes an aperture 420 that extends therethrough such that tubing (not shown) may be connected to the outer portion 414 for delivery of oxygen and air to the user. The oxygen and air delivery pack (not shown) may have a similar configuration to the oxygen and air delivery pack described with reference to the embodiment illustrated in FIGS. 1-7.

Since it is often difficult to convince babies and young children to retain oxygen and air delivery tubes on their faces, another embodiment of the mouthpiece 500 includes shape that is similar to play masks such as are worn for Halloween, as illustrated in FIG. 14. While the mouthpiece 500 is generally depicted as having a feline type shape, the mouthpiece 500 may have a variety of shapes to appeal to particular users.

The mouthpiece 500 includes tubing 502 that preferably extends at least partially therethrough for discharging oxygen and air proximate to the nostrils 504 of the person wearing the mouthpiece 500. The oxygen and air delivery pack (not shown) may have a similar configuration to the oxygen and air delivery pack described with reference to the embodiment illustrated in FIGS. 1-7.

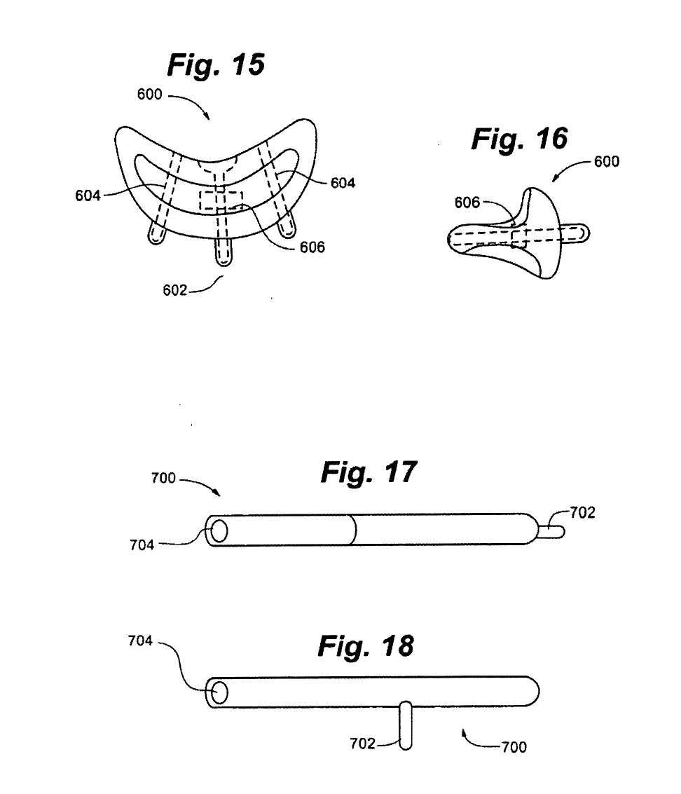

When performing certain activities, it is desired for the mouthpiece 600 to fit at least partially within the user's mouth, such as when swimming, playing football or playing hockey, as illustrated in FIGS. 15-16. This configuration of the mouthpiece 600 can be curved to generally conform to the curvature of the user's mouth.

The mouthpiece 600 includes at least one oxygen and air inlet port 602 and at least one oxygen and air outlet port 604. The oxygen and air inlet port 602 can include an air flow control 606 that is operated from pressure by the user's teeth so that when the user bites down on the mouthpiece 600, air flows through the mouthpiece 600 and into the user's mouth. The oxygen and air outlet port 604 can include a one-way valve that permits air to pass through the mouthpiece 600 when the user exhales.

Since many persons are in the habit of placing objects such as cigarettes and cigars into their mouths, the mouthpiece 700 may be shaped similar to a conventional cigarette or cigar, as illustrated in FIGS. 17-18.

The mouthpiece 700 generally includes an oxygen and air entry port 702 and an oxygen and air exit port 704. The oxygen and air entry port 702 is adapted for attachment to an oxygen and air delivery pack (not shown) using tubing (not shown) through either an end (FIGS. 15-17) or a side (FIG. 18) of the mouthpiece 700.

The oxygen exit port 704 may be shaped similar to the filter end on a conventional cigarette such that the user could replace the habit of periodically placing a cigarette into his/her mouth with putting the mouthpiece 700 into his/her mouth.

It is contemplated that features disclosed in this application, as well as those described in the above applications incorporated by reference, can be mixed and matched to suit particular circumstances. Various other modifications and changes will be apparent to those of ordinary skill.

1. A portable gas delivery system comprising:
a mouthpiece having an upper region and a lower region extending therefrom, wherein the upper region includes at least one nose port and wherein the lower region includes a mouth port;
a gas delivery pack having a gas storage region, a gas compression region, a gas filtration region or a combination thereof; and
a tubing assembly that is operably attached to the mouthpiece and the gas delivery pack for delivering gas from the gas delivery pack to the mouthpiece.

2. The portable gas delivery system of claim 1, wherein the mouthpiece further comprises a switch for controlling flow of oxygen and air through the mouthpiece.

3. The portable gas delivery system of claim 1, wherein the at least one nose port is capable of forming a substantially air-tight seal when inserted into a nostril.

4. The portable gas delivery system of claim 1, wherein the mouth port is capable of forming a substantially air-tight seal when inserted into a mouth.

5. The portable gas delivery system of claim 1, wherein the tubing assembly includes a least one rotatable connector at an intermediate location therein.

6. The portable gas delivery system of claim 1, and further comprising at least one adapter having a first recess and a second recess formed therein, wherein the first recess is adapted to receive a portion of the tubing assembly and wherein the second recess is adapted to receive a strap for mounting the tubing assembly with respect to a person's head.

7. A portable gas delivery system comprising:
a gas delivery pack having a gas storage region, a gas compression region, or a combination thereof;
a lower garment having at least one pocket, the pocket being adapted to receive the gas delivery pack;
a nosepiece having at least one nose port; and
a tubing assembly that is operably attached to the nosepiece and the gas delivery pack for delivering a flow of gas from the gas delivery pack to the nosepiece.

8. The portable gas delivery system of claim 7 further comprising an upper garment having at least one sheath attached thereto, the sheath or sheaths adapted to secure the tubing assembly to the upper garment.

9. A portable gas delivery system comprising:
a gas delivery pack having a gas storage region, a gas compression region, or a combination thereof;
a headpiece comprising: a tubular arm having a first end and a second end;
a nosepiece operably connected to the first end of the tubular arm, the nosepiece having at least one nose port;
a molded tube having a first and a second end, the first end operably connected to the tubular arm, the molded tube formed to mount to a person's body;
a tubing assembly that is operably attached to the second end of the molded tube and the gas delivery pack; and
the gas delivery pack, tubing assembly and headpiece being in fluid communication for delivering a flow of gas from the gas delivery pack to the nosepiece.

10. The portable gas delivery system of claim 9 wherein the tubing assembly includes a flow switch operably connected to switch the flow of gas on or off.

11. The portable gas delivery system of claim 9 wherein a cushion is attached to the molded tube.

12. The portable gas delivery system of claim 9 wherein the molded tube and the tubular arm are in fluid communication through a rotatable connector.

13. The portable gas delivery system of claim 9 wherein the molded tube is adapted to mount to a human ear.

14. A portable gas delivery system comprising:
a tubing assembly having a first end portion, a mid portion and a second end portion;
a mouthgrip operably connected to the first end portion of the tubing assembly;
a gas delivery pack having a gas storage region, a gas compression region, or a combination thereof, the gas pack operably connected to the second end portion of the tubing assembly;
a strap having a pouch attached thereto, the pouch adapted to receive the gas delivery pack; and
the gas delivery pack, tubing assembly and mouthgrip configured for delivering a flow of gas from the gas delivery pack to the mouthgrip.

15. The portable gas delivery system of claim 14 wherein the mid portion of the tubing assembly is an accordion style tubing and further comprising:
a holster case attached to the strap and adapted to house the mid portion of the tube assembly, the holster having an interior surface; and
one or more elasticized strings, each having a first end and a second end, the first end being attached to the interior surface of the holster case, the second end being attached to the mid portion of the tubing assembly, for retraction of the mid portion of the tubing assembly into the holster.

16. The portable gas delivery system of claim 15 wherein the mid portion of the tubing assembly is designed to fold where the elasticized string is connected to the mid portion.

17. The portable gas delivery system of claim 14 wherein the mouthgrip designed to release the flow of gas upon application of an external force.
